(19) United States
(12) Patent Application Publication
(10) Pub. No.: US 2009/0203349 A1
(43) Pub. Date: Aug. 13, 2009

(54) WIRELESS SECURITY SYSTEM

(75) Inventor: David Stuart Hollstien, Templeton, CA (US)

Correspondence Address: SHELDON MAK ROSE & ANDERSON PC, 100 Corson Street, Third Floor, PASADENA, CA, 91103-3842, US

(73) Assignee: TRIDENT SECURITY CONCEPTS, LLC, Templeton, CA (US)

(21) Appl. No.: 12/367,670

(22) Filed: Feb. 9, 2009

Related U.S. Application Data
(60) Provisional application No. 61/027,341, filed on Feb. 8, 2008.

(51) Int. Cl. H04M 11/04; G08B 1/08; H04W 4/00

(52) U.S. Cl. 455/404.1; 340/539.11; 455/466

(57) ABSTRACT

A wireless security system including a portable security apparatus for communicating in a point-to-point manner with a personal communication device in order to allow transmission of a signal indicating an alarm condition by the personal communication device to a remote user and to allow remote configuration of the system by the user.

### CROSS-REFERENCE TO RELATED APPLICATIONS

The present application claims the benefit of priority from copending U.S. Application No. 61/027,341, filed Feb. 8, 2008, the entire contents of which are hereby incorporated by reference.

### BACKGROUND

Current alarm systems are designed to warn of an impending loss of property by theft, catastrophic destruction or the like. Such alarm systems can contain sensors to detect motion, broken glass, smoke, fire, flood water, etc. Typically, the alarm systems notify a monitoring service center that an alarm condition exists.

Current systems also typically use conventional wired telephone lines to communicate with a monitoring service center. Conventional wired telephone lines, however, can be cut or disconnected by an intruder, thereby rendering the security system inoperative. The use of a monitoring service also increases the cost of the alarm system, as there is normally a recurring periodic fee for the monitoring service. Also, if a user changes monitoring services, the security system equipment purchased for use with the prior monitoring service may not be compatible with the services offered by the new monitoring service, thereby requiring a user to incur the additional expense of purchasing and installing new security equipment.

### SUMMARY

In view of the limitations of current alarm systems, there exists a need for an improved system, in particular an inexpensive, portable wireless security system with remote communications capability. The present wireless security system comprises at least two components, a portable alarm device and a personal communication device. The portable alarm device includes a plurality of sensors, a point-to-point radio transceiver for short-range data communication using a wireless protocol, and a battery for independent operation. The sensors can be, for example, an infra-red sensor, an accelerometer, a microwave motion sensor, an electric field detector, a thermal sensor, and/or a video camera. The personal communication device also comprises a point-to-point radio transceiver for short-range data communication using a wireless protocol, which can be paired with the point-to-point radio transceiver of the portable alarm device, in addition to including circuitry for wireless data communication over a switched telephone network and a battery for independent operation. The transceiver also preferably operates under a wireless protocol having a short range, for example under 100 meters, such as the BLUETOOTH protocol.

In a preferred embodiment, the personal communication device is a cellular telephone having a speed dial function. When a signal indicating an alarm condition is transmitted to the cellular telephone, the signal can include commands to recall a first number stored in the memory of the speed dial function and to dial the first stored number. If the stored number dialed by the cellular telephone does not result in a connection to a second telephone, then the portable alarm device can send commands to the cellular telephone to recall a second number stored in the memory of the speed dial function and to dial the second stored number.

The present system can further include a key fob having a point-to-point radio transceiver for communicating with a point-to-point transceiver in the portable alarm device. One or more external alarm sensors located outside the housing of the portable alarm device can likewise communicate with the portable alarm device using point-to-point radio transceivers, in order to transmit a signal to the portable alarm device indicating an alarm condition when the external alarm sensor is activated.

In use, the portable alarm device can transmit a signal when it detects an alarm condition to the personal communication device using the first point-to-point radio transceiver when one or more of the plurality of sensors is activated, and the personal communication device can then transmit a further signal to a user of the present system indicating the alarm condition over a telephone network. In order to protect an item using the present system, at least one portable alarm device is placed proximate to an item or area to be guarded, the portable alarm device is armed, and a personal communication device is paired with the portable alarm device and placed within range of the transceivers of the devices. Following the detection of an alarm condition by the portable alarm device, a second personal communication device of the user of the present system will receive a signal sent by the personal communication device indicating an alarm condition. The signal can be a tone command, an email message, or SMS message, and can contain a serial number of the portable alarm device. In embodiments in which the personal communication device includes an image capture device the image capture device can be positioned so as to capture an image when the portable security device sends a signal to the personal communication device indicating an alarm condition. The image can then be sent to and receive by a user's cellular telephone or other personal communication device.

In a preferred embodiment, a second portable alarm device can also be placed within communication range of the personal communication device paired with the first portable alarm device. The second portable alarm device is likewise paired with the personal communication device.

The present invention has several advantages not present in prior art alarm systems. Since the portable alarm device does not contain the electronics for communicating over a switched telephone network, it can be used with any of a number of different personal communications devices, and thus can be used with a variety of telephone networks. This increases the versatility of the portable alarm device without needing to include circuitry specific for a particular network. It also reduces the cost of the portable alarm device. Moreover, multiple portable alarm devices can be paired with a single cellular phone or other personal communications device, so that the circuitry needed for telephone communication need not be duplicated in each of the portable alarm devices.

In addition, because the personal communication device is housed in a different device housing and has an independent power source, it can be located away from the portable alarm device, preferably in a hidden or secure location. For example, if the portable alarm device is placed in the cargo compartment of a truck, the personal communication device can be placed in the passenger compartment of the truck. The personal communications device (and its circuitry) can thereby be spared damage or destruction of the portable alarm device is compromised by an intruder.

A further advantage of housing the portable alarm device and the personal communication device separately in the present system is that the personal communication device of the system can include a digital image capture device, and the digital image capture device can be used to record and transmit images both of the portable alarm device and of the items or area that it is guarding. When the portable alarm device senses an alarm condition, not only can the digital image capture device transmit a real-time image to a remotely located user, allowing the user to evaluate the situation, but it can also record and transmit information (images) that can be used to identify an intruder. Since the digital image capture device is not housed in the portable alarm device, the visual information regarding the alarm condition can be captured independently of the functioning of the portable alarm device, which an intruder might decide to disable following detection.

### DRAWINGS

FIG. 1 is a diagram of a remotely configurable wireless security system according to one embodiment of the present invention;

FIG. 2 is a diagram showing the pairing of a cellular phone with a portable security system useful in the system of FIG. 1; and

FIG. 3 is a block diagram of electronic components of a security system according to one embodiment of the present invention.

### DETAILED DESCRIPTION

### Definitions

“Alarm condition” refers to the occurrence of an action or condition which is detected by a sensor of the portable alarm device of the present system.

“BLUETOOTH” is a wireless protocol for exchanging data over short distances from fixed and mobile devices using radio frequencies. Devices using BLUETOOTH protocols have an effective range of about 1 meter, 10 meters, or 100 meters, depending on the particular protocol used.

“Pairing” refers to the establishment of a semi-permanent cryptographically authenticated trust relationship between two or more devices, using embedded identification codes and the same encryption protocol, and usually using a shared secret passkey. Paired devices can also encrypt data exchanged between the devices, thereby securing the communication or other data transmitted.

“Personal communication device” refers to an electronic device having long-range wireless communications capability, typically through a switched telephone network. Cellular telephones (cell phones) and satellite telephones are examples of such personal communications devices. Such devices can in some cases additionally support communications through, for example, the short message system (SMS), email, internet access, and BLUETOOTH band transmissions, among others. A range of at least about 5 kilometers of wireless communication, absent physical barriers, is preferable.

“Short range radio communication” refers to radio frequency communications using over a range of about 100 meters or less. BLUETOOTH protocols and Wi-Fi protocols (using IEEE 802.11 standards) allow such communication.

A “switched telephone network” is a communications network which establishes connections between communications devices, on demand and as available, in order to establish an end-to-end circuit between the devices. The connections are generally temporary, i.e. established only for the duration of the logical session or call, and exclusive, i.e. the connection and associated bandwidth are committed to only a particular call and are not shared with other transmissions. The Public Switched Telephone System is an example of a switched telephone network. Such a network can be accessed through a wired connection or through wireless connections, such as through a cellular telephone system or a satellite telephone system.

As used in this disclosure, except where the context requires otherwise, the term “comprise” and variations of the term, such as “comprising”, “comprises” and “comprised” are not intended to exclude other additives, components, integers or steps.

### Portable Alarm Device

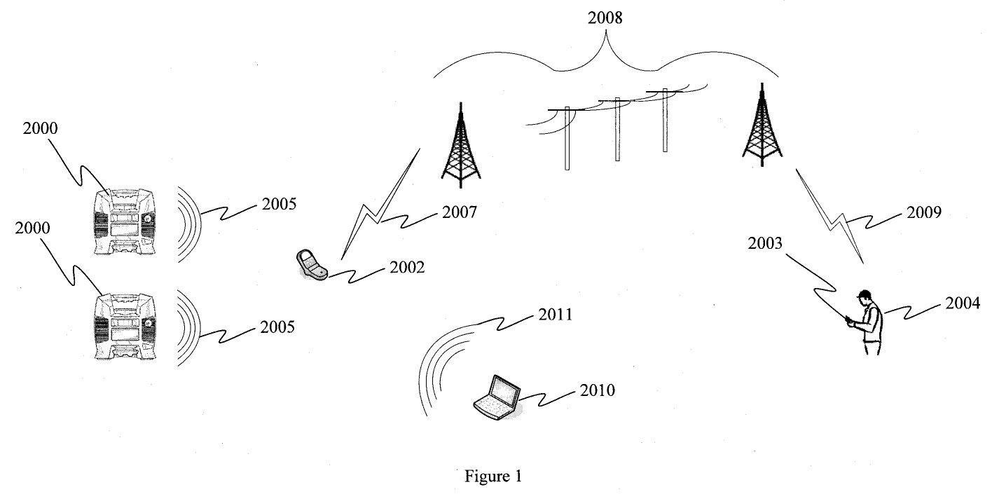

Referring now to FIG. 1, the present wireless security system includes a portable alarm device (2000) that can be used in conjunction with a BLUETOOTH enabled cellular telephone or other personal communication device to transmit remote notification of an alarm condition. The portable alarm device (2000) can be, for example, a self-contained system similar to that described in U.S. patent application Ser. No. 11/837,443 (entitled “Self-contained Security System,” which is hereby incorporated by reference into this application in its entirety) which detects the presence of an individual near the alarm device when one or more sensors associated with the device are triggered. The one or more sensors can comprise, for example, an infra-red sensor, an accelerometer, a microwave motion sensor, an electric field detector, a thermal sensor, and/or a video camera. The device can also preferably include an audible indication of an alarm condition, such as a siren, and/or a visual indication such as a flashing light.

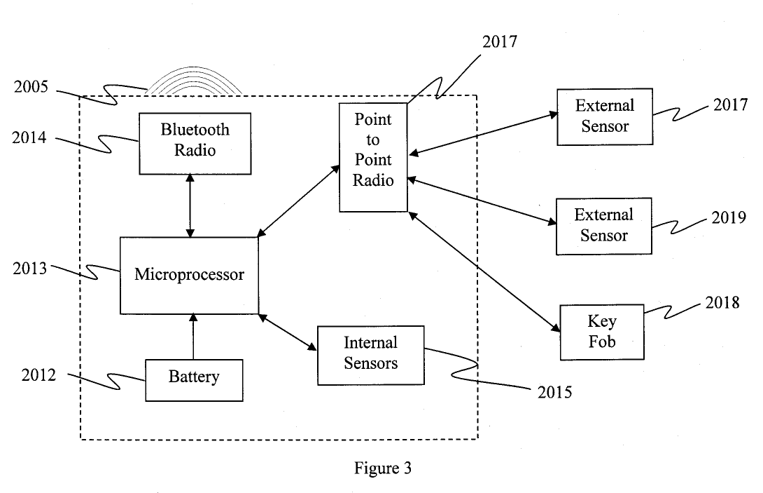

As shown in FIG. 3, the portable alarm device (2000) includes a battery (2012), control microprocessor (2013), internal alarm sensors (2015), a BLUETOOTH radio transceiver (2014), a point-to-point radio transceiver (2016) and optional external alarm sensors (2017). In a preferred embodiment, the battery (2012) is a low cost, lead acid type battery with a 7 Amp-hour storage capacity. The battery (2012) preferably provides power for the portable alarm device (2000) to operate for extended periods of time, such as for more than two-weeks on a single battery charge. The battery (2012) powers all of the electronic elements contained within the portable alarm device (2000).

Control microprocessor (2013), which can be a Microchip PIC18F45J10, contains software that monitors internal alarm sensors (2015) and communicates with external alarm sensors through a point-to-point radio transceiver (2016). In a preferred embodiment, the point-to-point radio transceiver (2016) is a Texas Instruments CC1101 transceiver operating at 433 MHz. Control microprocessor (2013) can contain software to communicate and send commands to external BLUETOOTH enabled devices through a BLUETOOTH radio transceiver (2014). In a preferred embodiment, the BLUETOOTH radio transceiver (2014) is a National Semiconductor LMX9838 module that contains an entire BLUETOOTH radio including an integrated antenna, which contains a baseband controller, 2.4 GHz radio, crystal, antenna, voltage regulator and passive components in a 10 mm×17 mm×2 mm module. Alternatively, the portable alarm device (2000) can include components to communicate with an external device, such as a personal communication device, using other protocols for short range radio communication, such as a Wi-Fi protocol.

The BLUETOOTH transceiver (2014) is preferably connected to the microprocessor (2013) via a standard UART serial port interface signals (2019). The microprocessor (2013) and the BLUETOOTH transceiver (2014) both preferably contain internal circuitry to support the UART serial port interface protocol. Preferably the baud (data communication) rate is at least 9600 baud. The UART serial port interface signals (2019) contain data signal lines (2020) and control signal lines (2021). The data signal lines (2020) allow for serial, full duplex data communication. The control signal lines (2021) are for flow control. The reset signal line (2022) is used to ensure that the BLUETOOTH transceiver (2014) is initialized properly.

During software operation, commands are issued and data is sent to the BLUETOOTH transceiver (2014) by the microprocessor (2013) over the data signal lines (2020). Control signal lines (2021) are used to reduce the data transfer rate to ensure that buffers in the BLUETOOTH transceiver (2014) are not overrun. Simultaneously, status and return data is sent to the microprocessor (2013) from the BLUETOOTH transceiver (2014) over the data signal lines (2020) while the control signal lines (2021) are used to reduce the data transfer rate to ensure that buffers in the microprocessor (2013) are not overrun.

The portable alarm device (2000) is preferably controlled by the user (2004) through a hand-held key fob device. The key fob contains a short range radio transmitter that sends messages to, e.g., select the alarm sensors and arm and disarm the system. The key fob is also used to initiate the pairing of the portable alarm device (2000) and a cellular telephone (2002).

When the portable alarm device (2000) is first powered on, the microprocessor (2013) initializes the BLUETOOTH transceiver (2014) and enters the Sensor Selection mode. While in this mode the user (2004) preferably can initiate the BLUETOOTH pairing by simultaneously pressing two buttons on the key fob. The pairing operation need only be performed one time for a given portable alarm device (2000) and cellular telephone (2002).

During BLUETOOTH transceiver (2014) initialization, microprocessor (2013) sets the internal mode of the BLUETOOTH transceiver (2014) to be “non-discoverable.” In this mode, a BLUETOOTH device, such as a laptop computer, cannot be used to detect the existence of the BLUETOOTH radio in the portable alarm device (2000). This makes it more difficult for an intruder to detect the presence of the portable alarm device (2000).

The BLUETOOTH transceiver (2014) stores a name string that is accessed during BLUETOOTH pairing and is made visible to the user (2004) on cellular telephone (2002). During BLUETOOTH transceiver Initialization, the microprocessor (2013) sets the name string to show the unique serial number imprinted on the back of portable alarm device (2000). The BLUETOOTH transceiver (2014) stores a passkey that is used during BLUETOOTH pairing. The passkey is commonly set to “0000” on BLUETOOTH Devices. The microprocessor (2013) sets the passkey to “0000” in BLUETOOTH transceiver (2014).

### Communication System

In the present system, the portable alarm device (2000) communicates with a personal communication device, such as a cellular phone (2002), in a point-to-point manner, preferably over a relatively short range using radio frequency signals. The personal communication device provides communication capability over a longer distance, to provide remote notification of an alarm condition detected by the portable alarm device (2000) to a user. The personal communication device comprises a housing separate from that of the portable alarm device (2000) and a separate power source, such as a battery, for independent operation. In a preferred embodiment, the portable alarm device (2000) comprises a BLUETOOTH radio and is paired with a BLUETOOTH enabled cellular telephone (2002). To pair the devices, user (2004) selects a command on cellular telephone (2002) to determine what BLUETOOTH devices are within range of cellular telephone (2002). If the portable alarm device (2000) is within range (approximately 100 meters for a BLUETOOTH class 1 device, 10 meters for a class 2 device, and 1 meter for a class 3 device), cellular telephone (2002) will display the serial number of the portable alarm device (2000). User (2004) completes the pairing procedure by entering the PIN number supplied with portable alarm device (2000) into the keypad on cellular telephone (2002).

Once the portable alarm device (2000) and a cellular telephone (2002) have been paired, the portable alarm device (2000) will attempt to communicate with the cellular telephone (2002) while it is in the Sensor Selection mode. An LED on the portable alarm device (2000) display panel is preferably lit to indicate when a BLUETOOTH link is established. This indicator notifies the user (2004) that the portable alarm device (2000) and the cellular telephone (2002) are in proper range and are ready to function in the event of an alarm condition.

Typically, cellular telephones support the BLUETOOTH Hands-Free and Dial-Up networking profiles. The Hands-Free and Dial-Up networking profiles define commands that allow telephone numbers to be dialed and a telephone connection to be established through the BLUETOOTH radio interface. The present invention preferably works in conjunction with cellular telephones and other communications devices that support the Hands-Free, the Dial-Up networking or both the Hands-Free and the Dial-Up networking profiles. In such embodiments, if an alarm condition is detected, the portable alarm device (2000) sends a command causing the personal communication device, e.g. cellular telephone (2002), to place a telephone call to a personal communication device at a remote location, preferably to the user (2004). The telephone number called by the personal communication device is defined by the user (2004), and it can be set to call a second personal communication device that is carried by the user (2004), for example.

In a preferred embodiment, the portable alarm device (2000) sends a command that preferably causes the personal communication device to recall and dial a “speed-dial” number that has been pre-entered. This allows the user to very easily enter and change the number the system will call upon detection of an alarm condition. Once a call is placed as a result of the detection of an alarm condition, the portable alarm device (2000) preferably issues commands to the personal communication device to produce a unique sequence of touch-tone signals that can be used by a touch-tone decoder in a second personal communication device to identify the specific portable alarm device (2000) and the type of alarm that was activated. The touch-tone decoder capability can be found on some “smart-phone” type cellular phones, among other communications devices. Software can also be loaded onto such devices that can display the portable alarm device (2000) and the alarm condition to the user.

In another embodiment, when the BLUETOOTH enabled personal communication device calls another BLUETOOTH enabled personal communication device, a special tone can be set so that the user will be immediately made aware that an alarm condition has been detected by the portable alarm device (2000). Alternatively or in addition, an SMS or text message can be sent by the personal communication device as a result of an alarm condition. The SMS message can contain an identifier signifying a particular portable alarm device (2000), such as the serial number of the particular portable alarm device (2000), and can also contain the type of alarm condition that resulted in the message being sent.

The present invention can also work with other BLUETOOTH-enabled communications devices, such as a computer or a marine radio. For example, the portable alarm device (2000) can be used with a BLUETOOTH enabled computer that is connected to the internet. When the portable alarm device (2000) is activated, a message sent via a BLUETOOTH capable radio can generate an email message to notify a user.

### BLUETOOTH Operation

In the preferred embodiment of the invention, the portable alarm device (2000) is paired with a cellular telephone (2002) that complies with the BLUETOOTH Hands-Free Profile (HFP), version 1.5. During the pairing operation, the control microprocessor (2013) issues a command to browse through the services provided by cellular telephone (2002) through BLUETOOTH radio transceiver (2014) to ensure that it supports the BLUETOOTH Hands-Free profile. The Hands-Free Profile defines the commands and responses required to control telephony operations in the cellular telephone (2002) by the portable alarm device (2000) via the BLUETOOTH radio interface. The Hands-Free Profile requires the BLUETOOTH Serial Port Profile to perform low level data transfers between the portable alarm device (2000) and cellular telephone (2002).

Upon initiation of BLUETOOTH pairing, the microprocessor (2013) clears any previous BLUETOOTH pairings. This allows the user (2004) to remove all BLUETOOTH pairings, if no other BLUETOOTH pairing is performed during the pairing period. During BLUETOOTH Pairing, the microprocessor (2013) sends commands to the BLUETOOTH transceiver (2014) to make it “discoverable” by other BLUETOOTH devices for a one minute pairing period. The BLUETOOTH transceiver (2014) and therefore the portable alarm device (2000) can be detected during a search of BLUETOOTH devices that is performed by the cellular telephone (2002). The name string contained in BLUETOOTH transceiver (2014) is typically displayed by the cellular telephone (2002). The user (2004) selects the portable alarm device (2000) on cellular telephone (2002) and the BLUETOOTH pairing process continues with the request for the passkey and the user (2004) enters in “0000”.

The BLUETOOTH pairing process takes place between the BLUETOOTH transceiver (2014) and the cellular telephone (2002) while the BLUETOOTH transceiver (2014) is discoverable, but does not involve or require specific pairing commands to be sent from the microprocessor (2013). The BLUETOOTH transceiver (2014) maintains a list of BLUETOOTH devices that have been successfully paired. The microprocessor (2013), requests this list to be sent by the BLUETOOTH transceiver (2014) at one second intervals. The pairing process is completed by the microprocessor (2013) when the list contains at least one BLUETOOTH pair entry. Upon completion of BLUETOOTH pairing, the BLUETOOTH transceiver (2014) is once again set to “non-discoverable” mode.

While the portable alarm device (2000) is in the Sensor Selection mode the user (2004) is allowed to select the desired sensor which will be used when the system is armed. While in this mode, it is important for the user (2004) to confirm that the BLUETOOTH link to cellular telephone (2002) can be established. This confirmation is to ensure that the communications link will occur properly when the portable alarm device (2000) detects an alarm condition.

Upon entry into the Sensor Selection mode, the microprocessor (2013) requests the list of paired BLUETOOTH devices from the BLUETOOTH transceiver (2014). If a paired BLUETOOTH device is in the list, the microprocessor (2013) then instructs the BLUETOOTH transceiver (2014) to establish a BLUETOOTH communications link to the first device in the list which is presumably the cellular telephone (2002). While the link is present an LED on the portable alarm device (2000) display panel is lit. The indicator is turned off if no BLUETOOTH device is in the list or if the BLUETOOTH link is not established.

### Alarm Activation

When the user (2004) arms the portable alarm device (2000), it becomes ready to detect an alarm condition. The communications link to the cellular telephone (2002) is then released and the BLUETOOTH transceiver (2014) is disabled to minimize power consumption.

Upon detection of an alarm condition, the portable alarm device (2000) reestablishes the BLUETOOTH communications link with the cellular telephone (2002) and initiates a dialing sequence. When the user (2004) receives the telephone call on telephone (2003) and answers it, the portable alarm device (2000) releases the BLUETOOTH link and returns to the armed mode. If the user (2004) does not answer the call received on telephone (2003), the portable alarm device (2000) preferably will continue to redial for the duration of the alarm condition, preferably three minutes.

The particular internal alarm sensors (2015) and external alarm sensors (2017) to be activated in the portable alarm device (2000) are selected by user (2004) prior to arming the portable alarm device (2000), preferably by pressing the appropriate buttons on key fob (2018). The sensor selections from key fob (2018) are communicated through point-to-point radio (2016). Once the sensor selections are made, the user (2004) arms the portable alarm device (2000) (i.e., activating one or more sensors and engaging circuitry in the portable alarm device which responds to an alarm condition, such as by communicating with the personal communication device) again using key fob (2018).

In a preferred embodiment, if control microprocessor (2013) determines that an alarm condition exists from an internal alarm sensor (2015) or from an external alarm sensor (2017) through point-to-point radio transceiver (2016), it issues a command to BLUETOOTH enabled communications device (2002) through a BLUETOOTH radio transceiver (2014) via BLUETOOTH signal (2005) to recall and dial a telephone number stored in a speed-dial location stored inside the cellular telephone (2002) at a memory location. Since the telephone number is stored within the cellular telephone (2002), control microprocessor (2013) does not store the telephone number for the user's cellular telephone (2003) thereby simplifying the construction of the portable alarm device (2000).

When the portable alarm device (2000) has detected an alarm condition in an internal sensor (2015) or from external sensor (2017), the microprocessor (2013) once again requests the list of paired BLUETOOTH devices from the BLUETOOTH transceiver (2014). If a paired BLUETOOTH device is in the list, then a Service Level Connection is with cellular telephone (2002). The Service Level Connection is established by issuing a prescribed set of command and status requests that are defined in the BLUETOOTH HFP specification.

Once the Service Level Connection is established, the microprocessor (2013) sends the Memory Dial Command String through the BLUETOOTH transceiver (2014) which is transmitted to the cellular telephone (2002), for example as follows:

ATD>50

This command causes the cellular telephone (2002) to dial a telephone number that was previously entered into location “50” of the telephone dial memory by the user (2004). The telephone number previously entered is the number for cellular telephone (2003). The complexity of the user interface on the portable alarm device (2000) is significantly reduced because it does not need to have the mechanism to enter and display the telephone number that will be called.

Upon receipt of the command from the portable alarm device (2000), cellular telephone (2002) initiates a wireless telephone call through signal (2007), preferably through a switched network such as the telephone network (2008), and through wireless connection (2009) (2009) to the user's cellular telephone (2003). The user (2004) recognizes the source of the call as being from cellular telephone (2002) and has been notified of an alarm condition in the portable alarm device (2000).

The status of the outgoing call is reported from the cellular telephone (2002) to the microprocessor (2013) via BLUETOOTH radio link (2005) and BLUETOOTH transceiver (2014). The status indicates when the outgoing call is active meaning the connection between cellular telephone (2002) and telephone (2003) has been established. The microprocessor (2013) redials by sending the Memory Dial Command String every 20 seconds while the portable alarm device (2000) is in the Alarm mode and until it receives an indication that the outgoing call is active.

Once the call status is reported to be active, the microprocessor (2013) stops redialing. This feature reduces the annoyance to the user (2004) since it stops the portable alarm device (2000) from calling when the user (2004) actually receives the call via telephone (2003).

### Additional Features

In a preferred embodiment, upon receipt of a telephone call initiated by the cellular telephone (2002), the user can input commands using the user's cellular telephone (2003) which are communicated to the cellular telephone (2002) and forwarded to portable alarm device (2000). For example, the user (2004) can input commands to reset an activated sensor and discontinue the alarm condition.

In another embodiment, multiple portable alarm devices (2000) and personal communication devices can be set up and armed. In a preferred embodiment, the personal communication devices are one or more cellular telephones (2002). The telephone number of each cellular telephone (2002) is unique, so that if each portable alarm device (2000) is paired with one cellular telephone (2002), when a user receives an indication of an alarm condition sent by one of the cellular telephones (2002), the identity of the cellular telephone (2002) contacting the user, and thus the identity of the portable alarm device (2000) signaling the alarm condition, will be known. A user of the present system can also associate a unique ring-tone for the signal received from a particular cellular telephone associated with a particular portable alarm device (2000).

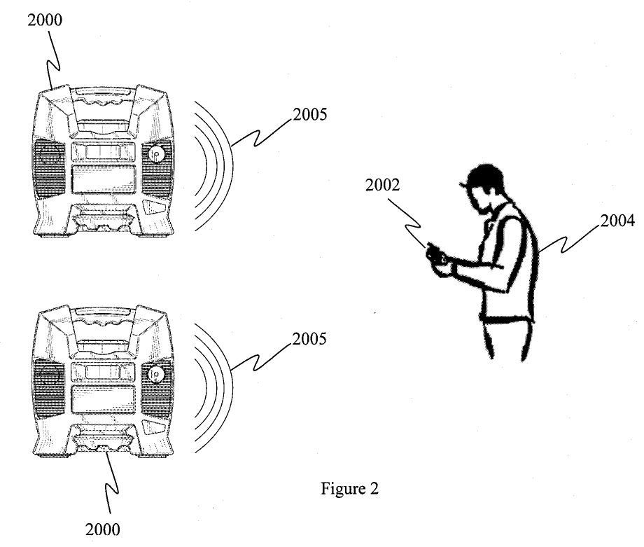

Alternatively, as shown in FIG. 2, multiple portable alarm devices (2000) can be paired with a particular cellular telephone (2002). If an alarm condition is detected by any of the paired portable alarm device (2000), this would cause control microprocessor (2013) to issue commands to the cellular telephone (2002) to place a call to the user's cellular telephone (2003). In this way, a single cellular telephone or other personal communication device can function to transmit information regarding alarm conditions for a plurality of portable alarm devices (2000).

In another embodiment, control microprocessor (2013) contained in portable alarm device (2000) can send commands to cellular telephone (2002) to generate touch-tone signals after the telephone connection to user's cellular telephone (2003) is established. The touch-tone signals uniquely identify the portable alarm device (2000) and, preferably, the type of alarm condition detected. In this embodiment, the user's cellular telephone (2003) also contains a means to decode touch-tone signals to display the identity of the particular portable alarm device (2000) associated with the signals and the alarm condition detected. The cellular telephone (2003) can also be loaded with a unique ring-tone that will only be generated upon receipt of a call from communications device (2002). This allows the user (2004) to immediately recognize the notification of an alarm condition in the portable alarm device (2000).

In further embodiment, cellular telephone (2002) can be set up with the telephone number of a monitoring service entered into its speed-dial function, such as at location 99, and this number can be used to call the monitoring service upon the receipt of an indication of an alarm condition by the portable alarm device (2000). The monitoring service can have equipment to decode the touch-tone signals identifying the particular portable alarm device (2000) and the user (2004). Human operators can then attempt a variety of methods to contact the user (2004).

If the cellular telephone (2002) is set to call a user of the present system (2004) directly using the speed dial function of the cellular telephone (2002), control microprocessor (2013) can issue commands to cellular telephone (2002) to recall and dial multiple speed-dial numbers, in serial fashion, upon detection of an alarm condition by portable alarm device (2000). In the event a user's cellular telephone (2003) is busy (i.e., if a connection does not result from dialing the telephone number) and/or rolls over to voicemail, for example, an alternate number can automatically be called by the cellular telephone (2002), for example using the speed dial function. Control microprocessor (2013) can, alternatively or in addition, issue commands to cellular telephone (2002) to recall and dial different speed-dial numbers based on the type of alarm condition detected by portable alarm device (2000).

In another embodiment, the software contained in control microprocessor (2013) can be updated through communication with another BLUETOOTH enabled device such as laptop computer (2010) via BLUETOOTH signal (2011).

In another embodiment, the software contained in control microprocessor (2013) can send the appropriate commands to cause the cellular telephone (2002) to capture an image using a digital image capture device in cellular telephone (2002) and transmit it to cellular telephone (2003). The digital image capture device can capture either still photos (in camera mode) or moving pictures (movie mode) or both, depending on the type of device associated with the cellular telephone (2003). If both functionalities are provided in the digital image capture device, then software associated with the control microprocessor (2013) is preferably provided to allow the user to select whether to have the digital image capture device operate in camera or movie mode.

One advantage of this feature of the present system is that the cellular telephone (2002) or other personal communication device can be placed at a distance from the portable alarm device (2000) and/or from the item or area being guarded by the portable alarm device (2000), and the digital image capture device can be positioned to capture visual images of the item or area being guarded as well as of the portable alarm device (2000). Preferably, the control microprocessor (2013) sends a command to the digital image capture device to capture and record images when one of the sensors of the portable alarm device (2000) is activated, such as in response to the presence of an intruder. If the intruder is not deterred by the portable alarm device (2000), such as by a siren activated by the portable alarm device (2000), and if the intruder steals or damages the portable alarm device (2000) or the property it is guarding, then the digital image capture device can record images that can be used to identify the intruder and later apprehend the intruder. Not only can such images be recorded and stored on the cellular telephone (2002) by the digital image capture device, but the cellular telephone (2002) can also be configured to send the images to the cellular telephone (2003) of the user (2004) so that the user can view the area being guarded and evaluate whether an alarm condition signaled by the portable alarm device (2000) is a true alarm condition, in response to an intruder, or is a false alarm, i.e. triggered by a non-threatening event. The images captured by the digital image capture device can also be sent to a different device located in a remote location having memory to store the images in order to securely retain the captured information.

In a further alternative, cellular telephone (2002) can capture sound with a microphone in response to a command from the control microprocessor (2013), in a like manner as images are captured by the digital image capture device described above, and can likewise forward the captured information. The sound can be captured either in connection with the capture of movie images, or separately.

Although the present invention has been discussed in considerable detail with reference to certain preferred embodiments, other embodiments are possible. Therefore, the scope of the appended claims should not be limited to the description of preferred embodiments contained in this disclosure. In addition, all dimensions specified in this disclosure are by way of example only and are not intended to be limiting. All references cited herein are incorporated by reference in their entirety.

What is claimed is:

1. A wireless security system comprising:
(a) a portable alarm device having a housing which comprises:
(i) a plurality of sensors;
(ii) a first point-to-point radio transceiver for short-range data communication using a wireless protocol; and
(iii) a battery; and
(b) a personal communication device having a housing that comprises:
(i) a second point-to-point radio transceiver for short-range data communication using a wireless protocol, wherein the second point-to-point radio transceiver can be paired to the first point-to-point radio transceiver;
(ii) circuitry for wireless data communication over a switched telephone network; and
(iii) a battery,
wherein the portable alarm device can transmit a signal indicating an alarm condition to the personal communication device using the first point-to-point radio transceiver when one or more of the plurality of sensors is activated, and wherein the personal communication device can transmit a further signal indicating the alarm condition over the switched telephone network.

2. The system of claim 1, wherein the personal communication device is a cellular telephone.

3. The system of claim 2, wherein the cellular telephone includes a speed dial function, and wherein the signal indicating an alarm condition transmitted to the cellular telephone comprises commands to recall a first number stored in the memory of the speed dial function and to dial the first stored number.

4. The system of claim 3, wherein if the stored number dialed by the cellular telephone does not result in a connection to a second telephone, then the portable alarm device sends commands to the cellular telephone to recall a second number stored in the memory of the speed dial function and to dial the second stored number.

5. The system of claim 1, wherein the personal communication device further comprises a digital image capture device.

6. The system of claim 1, wherein the personal communication device further comprises a microphone.

7. The system of claim 1, wherein the first point-to-point radio transceiver has a range of less than 100 meters.

8. The system of claim 1, further comprising a key fob having a point-to-point radio transceiver for communicating with the portable alarm device.

9. The system of claim 1, further comprising an external alarm sensor outside the housing of the portable alarm device, the external alarm sensor having a point-to-point radio transceiver, wherein the external alarm sensor can transmit a signal to the portable alarm device indicating an alarm condition when the external alarm sensor is activated.

10. The system of claim 1, wherein the wireless protocol used by the first point-to-point radio transceiver of the portable alarm device is a BLUETOOTH protocol.

11. A method for protecting an item to be guarded using a wireless security system, comprising the steps of:
a) providing at least one portable alarm device comprising a plurality of sensors and a first point-to-point radio transceiver for short-range data communication using a wireless protocol;
b) providing a personal communication device comprising a second point-to-point radio transceiver for short-range data communication using a wireless protocol;
c) securely pairing the portable alarm device and the personal communication device;
d) placing the portable alarm device proximate to an item to be guarded;
e) placing the personal communication device within communication range of the first point-to-point radio transceiver of the portable alarm device; and
f) following the detection of an alarm condition by the portable alarm device, receiving a signal indicating an alarm condition from the personal communication device.

12. The method of claim 11, wherein the personal communication device comprises an image capture device, further comprising the step of positioning the image capture device so as to capture an image when the portable security device sends a signal to the personal communication device indicating an alarm condition.

13. The method of claim 12, further comprising the step of receiving a captured image from the personal communication device.

14. The method of claim 11, further comprising the step of placing a second portable alarm device within communication range of the second point-to-point radio transceiver, wherein the second portable alarm device comprises:
(i) a plurality of sensors; and
(ii) a third point-to-point radio transceiver for short-range data communication using a wireless protocol,
wherein the second portable alarm device is securely paired with the personal communication device.

15. The method of claim 11, further comprising the step of arming the portable alarm device.

16. The method of claim 11, wherein the signal received from the personal communication device is a tone command to alert a user of the portable alarm device that an alarm condition has been detected.

17. The method of claim 11, wherein the signal is received on a cellular telephone.

18. The method of claim 17, wherein the cellular telephone receives an SMS from the personal communication device as a result of the alarm condition.

19. The method of claim 18, wherein the SMS message contains a serial number of the portable alarm device.

20. The method of claim 18, wherein the SMS message contains an indication of the type of alarm condition detected by the portable alarm device.
